(19) United States
(12) Patent Application Publication
(10) Pub. No.: US 2002/0098000 A1
(43) Pub. Date: Jul. 25, 2002

(54) Film cassette engagement and disengagement

(76) Inventor: Ivan Lau, Hong Kong (HK)

Correspondence Address: SAMUEL BORODACH, Fish & Richardson P.C., Suite 2800, 45 Rockefeller Plaza, New York, NY, 10111, US

(21) Appl. No.: 09/948,229

(22) Filed: Sep. 7, 2001

Related U.S. Application Data
(60) Provisional application No. 60/231,772, filed on Sep. 12, 2000.

(51) Int. Cl. G03B 1/00

(52) U.S. Cl. 396/395

(57) ABSTRACT

A strip of photographic film is moved relative to the photographic film cassette from which the strip extends. A rewinding apparatus can be selectably engaged or disengaged from the film spool of the photographic film cassette. The techniques can be used in cameras, including low-cost or disposable cameras.

### RELATED APPLICATIONS

This application claims the benefit of priority from U.S. Provisional Application Serial No. 60/231,772, filed on Sep. 12, 2000.

### BACKGROUND

This invention relates to photographic cameras and more particularly to film cassette engagement and disengagement in connection with reloading/preloading the film in a camera.

Disposable cameras provide a convenient and low cost way of taking pictures. A user does not have to purchase expensive and complicated photography equipment, and does not have to be an expert in photography to take pictures. After all exposures are taken, the camera is given to a photo shop or photo laboratory without the user having to remove the film. If the user wants to take more pictures, he simply has to buy another camera.

Disposable cameras have disadvantages in that the casing of the camera is discarded, creating waste of materials and hazards to the environment. The inability to reuse the camera creates these disadvantages. Disposable cameras are not reusable because they are designed to be opened only by destroying the case. As a consequence, there is no way to reload the camera with film. Some disposable cameras have the ability to be rewound. However, there is a need for a disposable camera that is reusable. It would be desirable to have a camera in which new film could be reloaded and rewound, and a device that would be useable in such a camera to rewind and reload film.

### SUMMARY

An arrangement is disclosed which permits a user of a camera to cause the strip of film, which is attached to a film winding spool inside that photographic film cassette, to translate with respect to the photographic film cassette, e.g., to be rewound back within the photographic film cassette after having been extracted from same. An aspect of the arrangement includes an advance wheel which is rotatably secured within the camera and a claw arrangement which is attached to the advance wheel by virtue of rails on a top surface of the advance wheel passing through sleeves in the claw arrangement. The combination of the claw arrangement with the advance wheel is termed the advance wheel mechanism. The connection between the advance wheel and the claw arrangement prevents them from rotating with respect to one another, but allows the claw arrangement to move up and down along the rails. An uppermost limit to the distance the claw arrangement can move along the rails exists and prevents the advance wheel and claw arrangement from becoming separated. A resilient member tends to urge the claw arrangement upward along the rails, causing it to reach the uppermost limit of its vertical traverse when no obstruction exists to prevent such upward movement. As the arrangement is deployed within a camera, when the claw arrangement is at the upper limit of its vertical traverse, no rotatable engagement is possible between it and the film winding spool of the photographic film cassette. However, the user can selectably urge the claw arrangement down along the rails to a point where the rotatable engagement will occur. When the claw arrangement is in this position, the user can use the advance wheel mechanism to move the strip of photographic film in the rewind direction, i.e., back into the photographic film cassette.

Another aspect of the arrangement includes means for automatically locking the advance wheel mechanism in its rotatably engaged position with respect to the film winding spool once the user moves the claw arrangement downward past a certain point in its vertical traverse. Yet another aspect of the invention prevents the user from unlocking the claw arrangement from its rotatably engaged position with respect to the film winding spool until the rear door of the camera is released, the lock is automatically released, and the large resilient member urges the claw arrangement back up to the uppermost limit of its vertical traverse. Still another aspect of the invention includes a cantilevered ratchet arm, engaged with knurling on the advance wheel, which prevents the user (once the claw arrangement mechanism is in its rotatably engaged and locked position with regard to the photographic film cassette) from using a pre-winding key attached to a pre-wound film take-up spool to move the strip of photographic film in the pre-wind (opposite to rewind) direction. A further aspect of the invention includes a preventer which prevents a user from rotating the pre-wound film take-up spool in any other direction than the pre-wind direction.

In a related aspect of the invention, a method is disclosed which allows a user to move a strip of photographic film within a camera relative to the photographic film cassette from which the strip extends. An aspect of the method provides rewinding means for rotating the film winding spool of the photographic film cassette in the rewind direction. Another aspect of the method provides disengagement means which prevent rotatable engagement between the rewinding means and the film rewinding spool. Yet another aspect of the method provides engagement means for selectably establishing rotatabe engagment between the rewinding means and the film rewinding spool. A further aspect of the method involves using the disengagement means to prevent rotatable engagement between the rewinding means and the film rewinding spool while pre-winding the strip of photographic film out of the photographic film cassette and into a pre-wound film storage area. Yet another aspect of the present method involves utilizing the engagement means to establish rotatable engagement between the rewinding means and the film winding spool. Still another aspect of the present method involves and utilizing the rewinding means to rewind the strip of photographic film back into the photographic film cassette.

Accordingly, the invention describes an arrangement and a method associated with a low cost and convenient camera which can be reused and reloaded each time all exposures of a film cassette are used. The invention also provides a mechanism to allow a user to rewind and reload film. The mechanism prevents a user from advancing film in a cassette until a prewinding process is complete. In addition, the invention prevents a user from rewinding or prewinding used film in the middle of the roll.

The details of an embodiment both of the arrangement and of the method are set forth in the accompanying drawings and the description below. Other features, objects, and advantages of the invention will be apparent from the description, and drawings, and from the claims.

### BRIEF DESCRIPTION OF THE DRAWINGS

FIG. 1A is an exposed rear view of a camera with an implementation of a film engagement and disengagement apparatus.

FIG. 1B is an exposed top view of a camera with an implementation of a film engagement and disengagement apparatus.

FIG. 2 is an exploded view of an implementation of the engagement and disengagement apparatus; FIG. 2A is a detail view of a portion of FIG. 2.

FIG. 3A and FIG. 3B are top and side views, respectively, of a camera at a first point of the film cycle of the present invention, i.e., that point at which the camera is in its reset condition, after the rear door is released and the photographic film cassette is inserted in the camera, but prior to pre-winding of the film.

FIG. 4A and FIG. 4B are top and side views, respectively, of a camera at a second point of the film cycle of the present invention, i.e., that point when the leader portion of the strip of photographic film is attached to the pre-wound film take-up spool, and the rear door is ready to be replaced.

FIG. 5A and FIG. 5B are top and side views, respectively, of a camera at a third point of the film cycle of the present invention, i.e., that point when the rear door of the camera has been replaced and the camera is ready for pre-winding of the strip of photographic film.

FIG. 6A and FIG. 6B are top and side views, respectively, of a camera at a fourth point of the film cycle of the present invention, i.e., the winding key is inserted into the rotation interface and rotated, thus rotating the pre-wound film take-up spool, and also pulling the strip of photographic film from the photographic film cassette, causing it to be wrapped around the pre-wound film take-up spool.

FIG. 7A and FIG. 7B are top and side views, respectively, of a camera at a fifth point of the film cycle of the present invention, i.e., the strip of photographic film has been pre-wound, and the advance wheel knob is depressed, triggering the deployment of a locking component (knob stopper) which holds the advance wheel mechanism in rotatable engagement with the film winding spool of the photographic film cassette.

FIG. 8A and FIG. 8B are top and side views, respectively, of a camera at a sixth point of the film cycle of the present invention, i.e., the point when photographs are taken and the strip of photographic film is gradually rewound back within the photographic film cassette.

FIG. 9A and FIG. 9B are top and side views, respectively, of a camera at a seventh point of the film cycle of the present invention, i.e., the film has been fully exposed and rewound, and the rear door may be released (causing the camera to revert to the reset condition), and the photographic film cassette can be removed.

### DETAILED DESCRIPTION

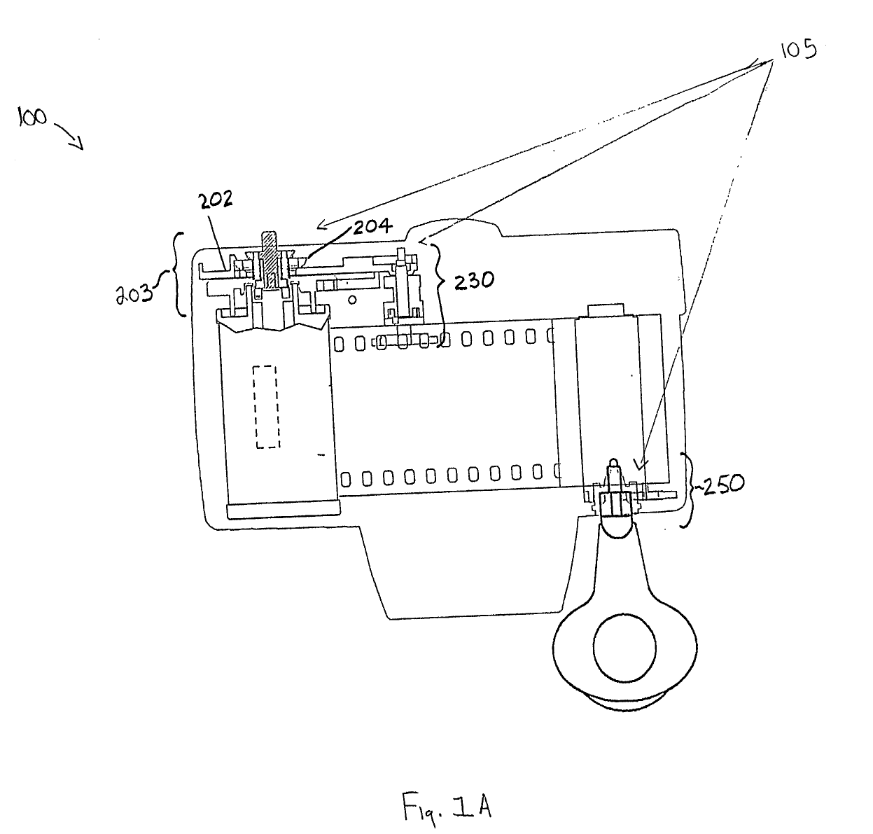

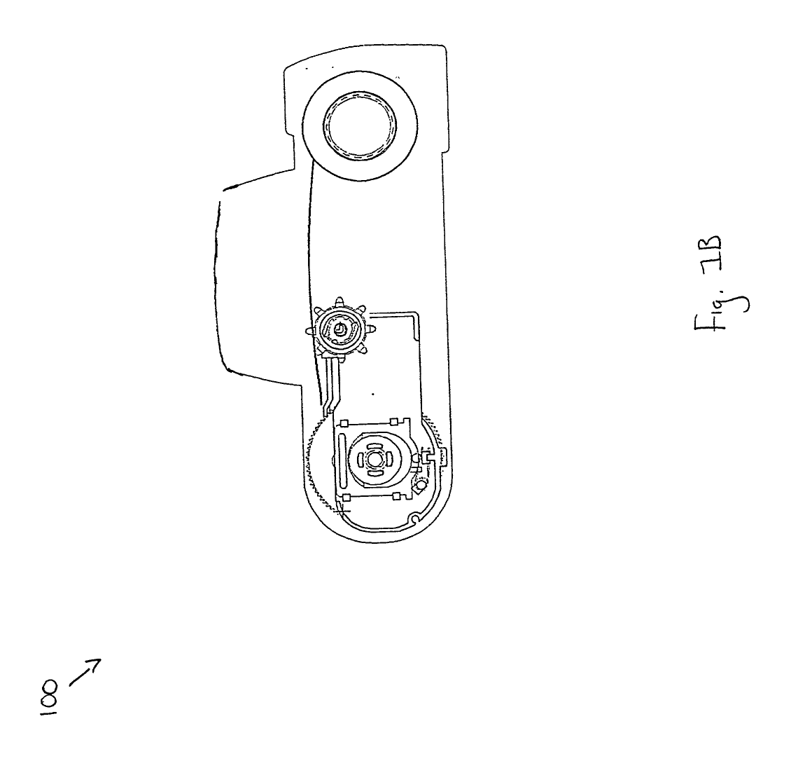

Referring to FIG. 1A, an exposed rear view of a camera 100 is shown which includes an implementation of a film engagement and disengagement apparatus 105. The apparatus 105 includes a top plate 202, a knob stopper 204, an advance wheel mechanism 203, a sprocket mechanism 230 and pre-winding arrangement 250. FIG. 1B is an exposed top view of the camera 100.

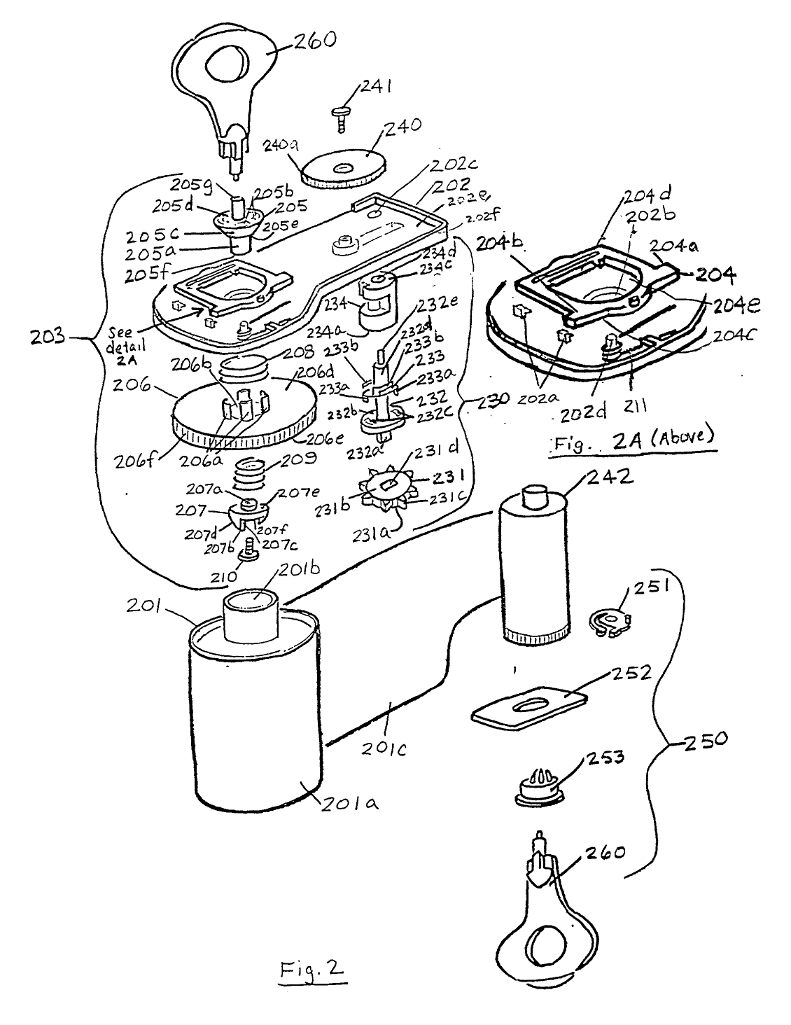

FIG. 2 and FIG. 2A illustrate an exploded view of an implementation of the film engagement and disengagement apparatus 105 shown in FIGS. 1A-1B. A typical photographic film cassette 201 is shown with a film cassette housing 201a, film winding spool 201b, and strip of photographic film 201c. The apparatus 105 includes the top plate 202, having four knob stopper retention prongs 202a (two aligned prongs are shown, two opposing prongs are obscured), knob clearance hole 202b, shaft spindle clearance hole 202c, resilient member mounting post 202d, top plate upper surface 202e, and top plate lower surface 202f. Counter dial 240 is shown with counter dial mechanical fastener 241 above its rotatable mounting location on top plate 202. Counter dial knurling 240a is also shown. Knob stopper 204 is shown in FIG. 2A with two rearward facing knob stopper lateral surfaces 204a (one is indicated), knob stopper upper surface 204b, knob stopper lower surface 204c, knob stopper angled surface 204d, and knob clearance hole 204e.

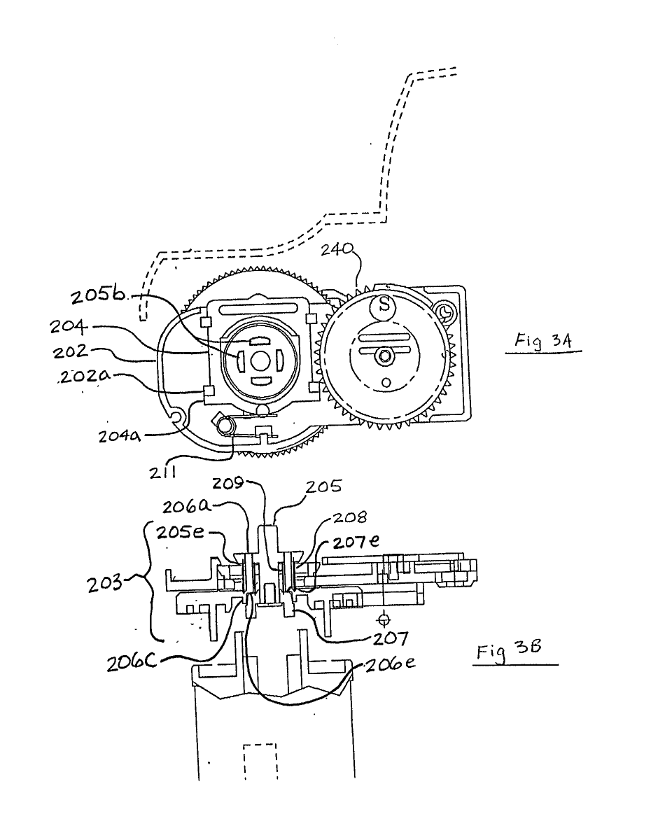

The components of advance wheel mechanism 203 are also indicated in FIG. 2, all of which are arranged around a common central axis. Advance wheel knob 205 is shown, with claw engagement rail 205a, knob engagement rail sleeve 205b, conical side surface 205c, knob upper surface 205d, knob lower surface 205e, claw mounting fastener hole 205f, and knob depression button 205g. Advance wheel 206 is shown, with knob engagement rails 206a (four are shown), claw engagement rail clearance hole 206b, claw retention projection 206c (shown in FIG. 3B), advance wheel upper surface 206d, advance wheel lower surface 206e, and advance wheel knurling 206f. Advance wheel claw 207 is shown, with claw engagement rail hole 207a, two film winding spool engagement teeth 207b, film winding spool engagement surface 207c, spiral-shaped rear portion 207d of teeth 207b, claw upper surface 207e, and claw lower surface 207f. Large diameter resilient member 208, small diameter resilient member 209, and claw mounting fastener 210 are also shown.

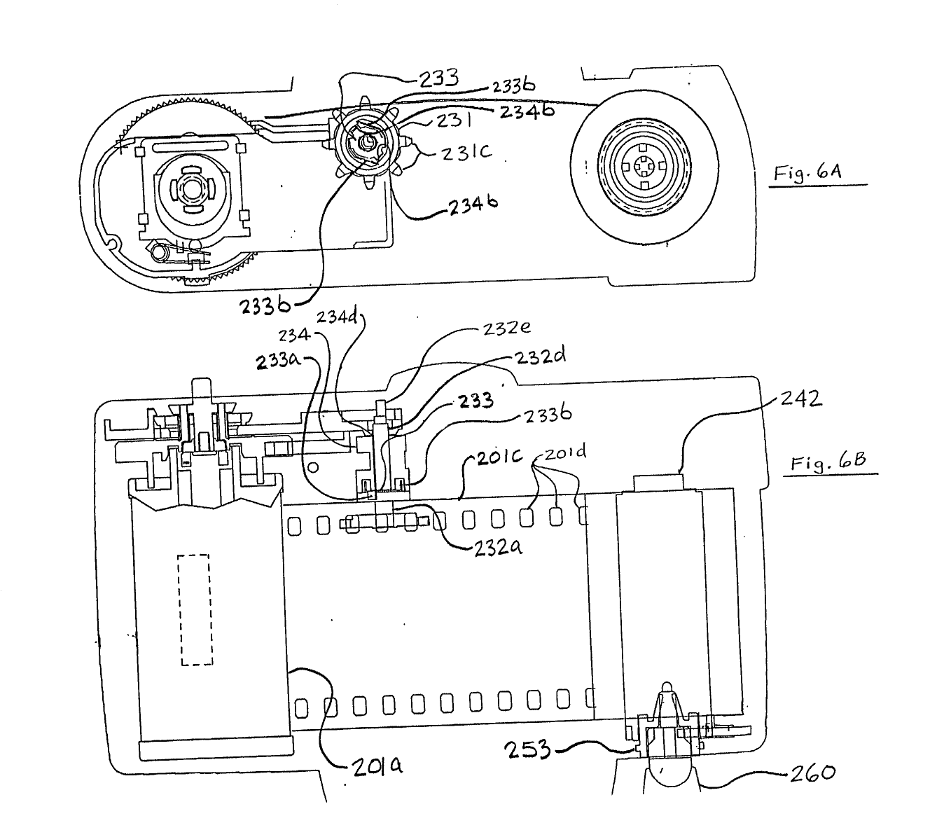

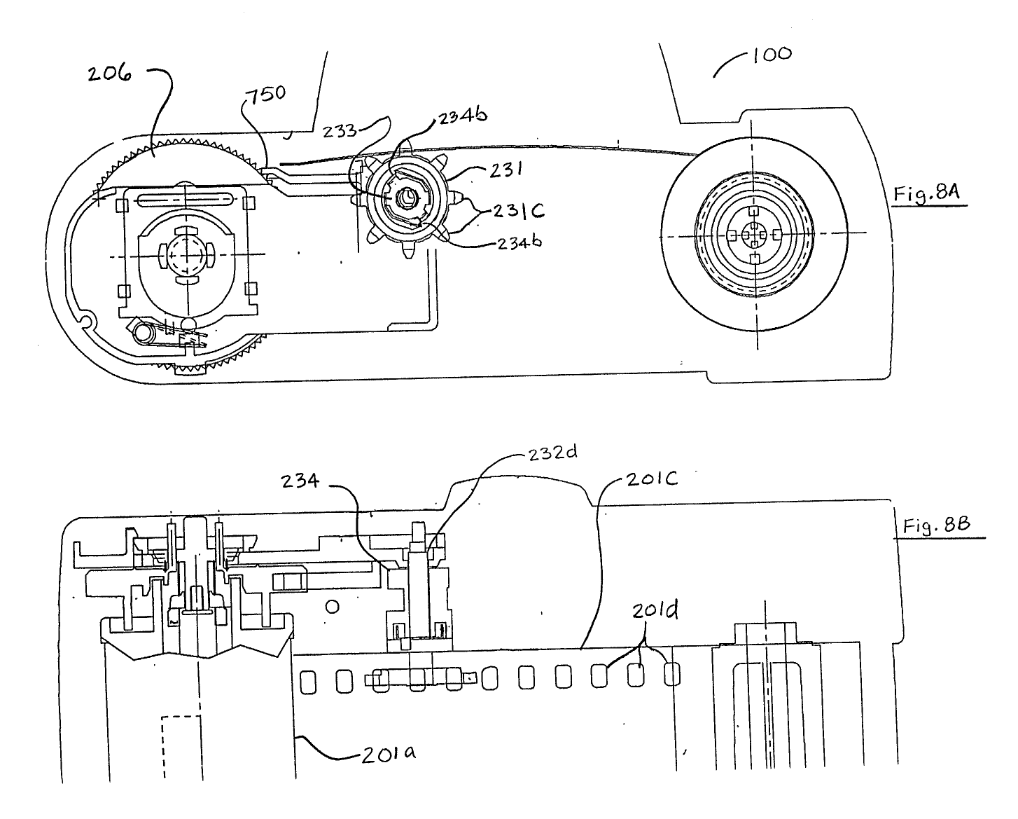

The components of sprocket mechanism 230 are also indicated in FIG. 2, all of which are arranged around a common central axis. Sprocket 231 is shown, with sprocket lower surface 231a, sprocket upper surface 231b, film engagement teeth 231c, and shaft engagement hole 231d. Shaft 232 is shown, with sprocket engagement post 232a, sprocket engagement plate 232b, ratchet plate engagement holes 232c, shaft spindle 232d, and counter dial engagement gear 232e. Ratchet plate 233 is shown, with two shaft engagement tabs 233a and two cam engagement prongs 233b. Cam plate 234 is shown, with cam engagement prong engagement channel 234a, two cam engagement prong engagement teeth 234b (shown in FIG. 6A and FIG. 8A), top plate engagement face 234c, and shaft spindle sleeve 234d.

The components of pre-winding arrangement 250 are also indicated in FIG. 2, all of which, with the exception of preventer 251, are arranged around a common central axis which they share with pre-wound film take-up spool 242. Bottom plate 252, rotation interface 253 and winding key 260 are all shown. Winding key 260 is shown again above knob depression button 205g.

Top plate resilient member is shown in Detail 2A of FIG. 2 mounted on resilient member mounting post 202d.

Referring to FIG. 3A and FIG. 3B, a first point is shown of a film cycle which includes the processes of loading film in the camera, pre-winding the film within the camera, exposing the film within the camera, and removing the exposed film from the camera, leaving it ready for insertion of a new unexposed photographic film cassette. At the first point, the camera is at the reset position. The rear door of the camera is released, there is no film inside the camera, and the counter dial may be set to indicate ‘S’, or if it indicates a different number, it can be moved to indicate ‘S’ by manual rotation until it stops at ‘S’. The knob stopper 204 remains in the open position by the force of top plate resilient member 211, with rearward-facing knob stopper lateral projections 204a resting against their respective knob stopper retention prongs 202a. Advance wheel knob 205 is kept in its pop-up position by the force of large resilient member 208 urging lower surface 205e of the advance wheel knob upward, with knob engagement rails 206a located within knob engagement rail sleeves 205b. The advance wheel claw 207 is kept in its default low position by the force of small resilient member 209 urging claw upper surface 207e downward. Because claw upper surface 207e also rests against advance wheel lower surface 206e, the knob and claw portion of advance wheel knob mechanism 203 is prevented from moving upward any more than what is shown in FIG. 3. Advance wheel claw 207 is fixed in a centered position against the advance wheel 206 by claw locating projection 206c.

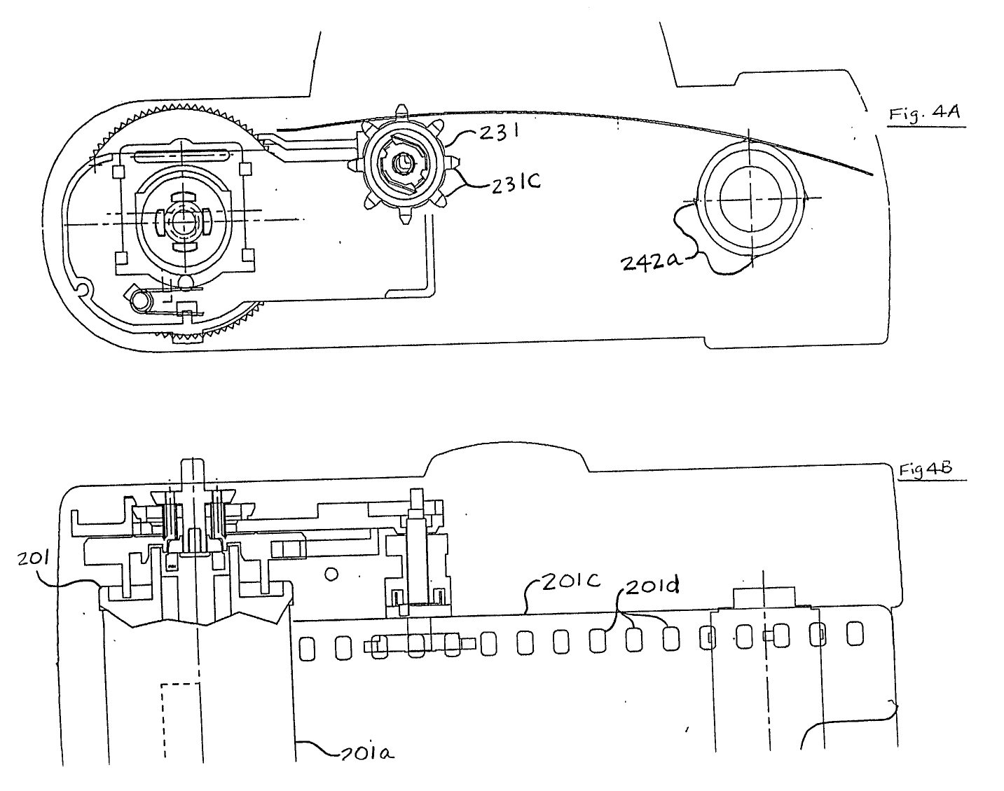

Referring to FIG. 4A and FIG. 4B, a second point of the film cycle is shown. At the second point, an unexposed photographic film cassette 201 is inserted within the film cassette storage chamber of the open camera housing, a leader portion of strip 201c of photographic film is manually pulled from the film cassette housing 201a, edge-located gear-engaging perforations 201d of strip 201c of photographic film are caused to be engaged with film engagement teeth 231c of sprocket 231, and the end of the leader portion of the strip 201c of photographic film is attached to at least one film engagement hook 242a of the pre-wound film take-up spool 242. Once this is done, the rear door of the camera housing can be replaced, thus completing the camera housing.

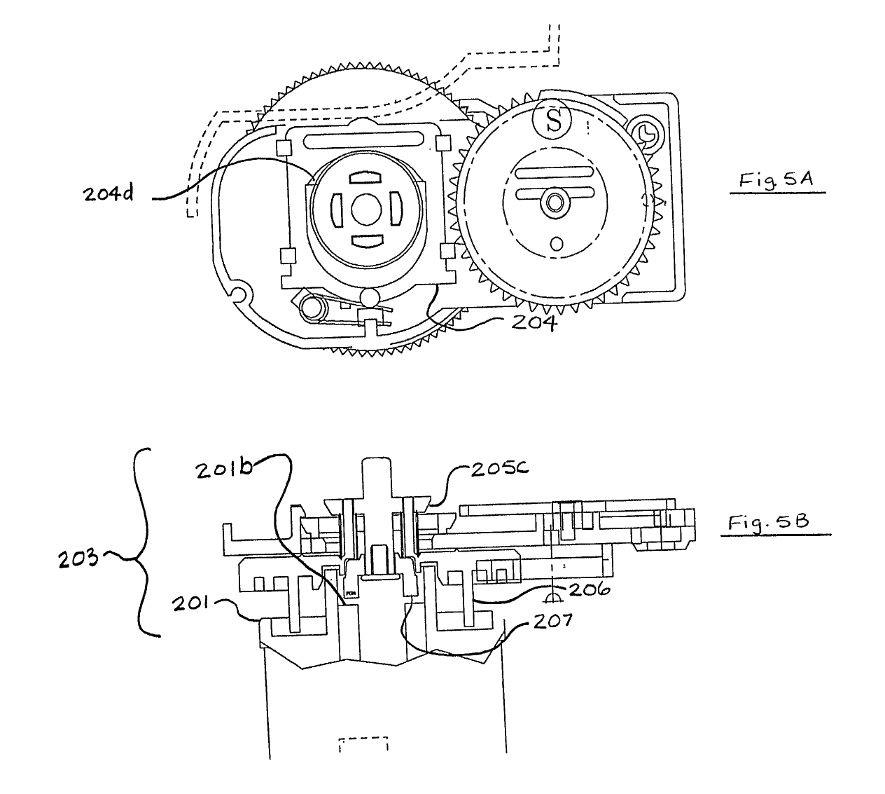

Referring to FIG. 5A and FIG. 5B, a third point of the film cycle is shown. At the third point, the rear door of the camera housing is replaced, the photographic film cassette 201 is in place within the camera, and the camera is ready for pre-winding of the strip 201c of photographic film. The location of the advance wheel mechanism 203, the knob and claw portion of which is maintained in the pop-up position by the force of large resilient member 208, is unchanged. The knob stopper 204 is urged by the superior force of the rear door from its default rear position to a more forward position at which it presents an obstruction to the previously unobstructed downward path of the advance wheel knob 205. More specifically, the upward-facing knob stopper angled surface 204d is located near or against the downward facing conical side surface 205c of the advance wheel knob 205. FIG. 5A shows the advance wheel knob 205 obscuring the knob stopper angled surface 204d, thus demonstrating the pop-up position of the advance wheel mechanism 203 occurring contemporaneously with the more forward position of the knob stopper 204. Further describing the condition of the camera at the third point of the film cycle, the advance wheel claw 207 remains in its default upward position against the advance wheel 206, and the film winding spool 201b of the photographic film cassette 201 remains unengaged.

Referring to FIG. 6A and FIG. 6B, the fourth point of the film cycle is shown. At the fourth point, winding key 260 is inserted into the rotation interface 253 and rotated in the pre-wind direction, rotating the pre-wound film take-up spool 242, pulling the strip 201c of photographic film from the film cassette housing 201a, causing it to pass to the other side of the camera, and to be wound around the pre-wound film take-up spool 242. Preventer 251 prevents a user from using the winding key 260 to rotate the pre-wound film take-up spool in the direction opposite from the pre-wind direction. Because gear-engaging perforations 201d are engaged with film engagement teeth 231c of sprocket 231, the pre-winding movement of the strip of photographic film causes the sprocket to spin, which causes the ratchet plate 233, attached to sprocket 231 by means of shaft engagement tabs 233a, to spin in unison with the sprocket. However, in this direction of sprocket spin (i.e., pre-wind) the cam engagement prongs 233b of the ratchet plate skip past the teeth 234b of the cam plate 234 with which they are designed to engage in the opposite direction of sprocket spin (rewind). As a result, though the shaft spindle 232d, attached to the sprocket by sprocket engagement post 232a, is sleeved within the shaft spindle sleeving hole 234d of the cam plate 234, and spins in unison with the sprocket, the cam plate is not subject to any appreciable torquing force from the ratchet plate and does not spin during pre-wind of the film. However, because the shaft spindle 232d does spin during pre-wind, the counter dial engagement gear 232e of the shaft spins as well, driving the counter dial 240 to spin, and the count of available exposures, indicated by numerals visible to the user as they pass under a viewing hole in the camera housing, to rise in proportion to the length of film removed from the film cassette housing 201a. As such, if the photographic film cassette 201 holds sufficient film for 27 exposures, and the film is completely pre-wound, the numeral appearing through the viewing hole will be 27; if a complete pre-wind produces sufficient film for 24 exposures, the numeral appearing will be 24, and so on.

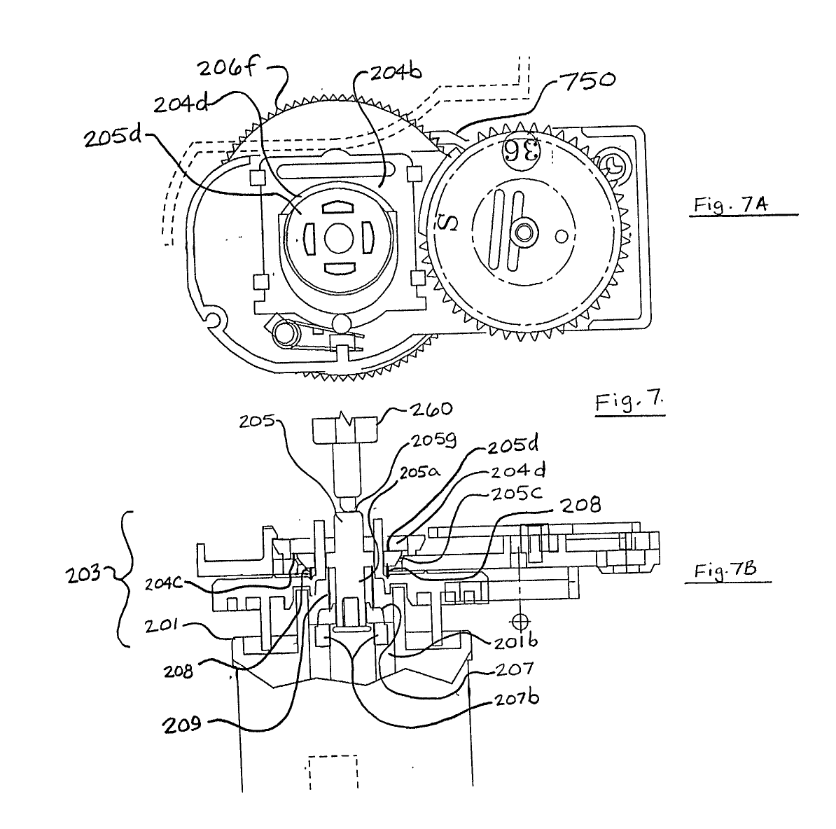

Referring to FIG. 7A and FIG. 7B, a fifth point of the film cycle is shown. The switch from the fourth point to the fifth point is to be undertaken after the user has completed pre-winding the film, and is accomplished by the user urging the advance wheel knob 205 downward so that the advance wheel claw 207 can engage the film winding spool 201b of the photographic film cassette 201. The winding key 260 can be used to urge the advance wheel knob downward by the user holding the key upright, placing the small diameter end of the key against the center of the top surface of the knob depression button 205g, and pushing downward on the winding key. Initially, this will cause the downward facing conical side surface 205c of the advance wheel knob 205 to press and slide against the knob stopper angled surface 204d, which will cause the advance wheel mechanism 203 to tilt slightly forward, and the knob stopper to move rearward to the extent the rear door of the camera can flex to accommodate the rearward movement of the knob stopper 204. Once the upper surface 205d of the advance wheel knob moves below the lower surface 204c of the knob stopper, the knob stopper will ‘snap’ forward by the force of the relaxing flex of the rear door to a position over the upper surface 205d of the knob stopper, and the slight forward tilt of the advance wheel mechanism 203 will be relieved, since the angled surface 204d of the knob stopper will no longer be in interference with the downward facing conical side surface 205c of the advance wheel knob. The large resilient member 208 is thus placed in a more compressed state. In this way the upper surface 205d of the knob stopper, which is biased toward its pop-up position by the force of large resilient member 208, will be prevented from moving upward by the presence of the ‘ceiling’ now formed by the lower surface 204c of the knob stopper. At this point, the downward force applied to the knob depression button 205g can be removed, because the advance wheel claw will be held in proper position to engage the film winding spool 201b of the photographic film cassette. The advance wheel mechanism 203 itself will thus be locked in an engaged position with regard to the film winding spool 201b of the photographic film cassette 201, a condition which will persist until such time as the knob stopper is allowed to move rearward (i.e., when the rear door of the camera housing is removed, which happens after the film is fully rewound). If for any reason (e.g., initial angular misalignment) the advance wheel claw 207 is not fully engaged with the film winding spool 201b of the photographic film cassette 201 immediately after the depression and downward-locking of the advance wheel knob 205, it will become so engaged once the user begins to utilize the advance wheel to rewind the film. This gradual ‘seating’ of what may be an initially misaligned advance wheel claw occurs because a) the spring force of small resilient member 209 tends to force the advance wheel claw 207 downward along claw engagement rail 205a toward full engagement with the film winding spool 201b, and b) the spiral-shaped rear portions 207d of the spindle engagement teeth 207b of the advance wheel claw 207 allow the advance wheel to slide along corresponding structure of the film winding spool 201b and gradually drop into its spindle-engaging position. FIG. 7A shows the upper surface 204b and angled surface 204d of the knob stopper 204 obscuring the upper surface 205d of the advance wheel knob, thus demonstrating the downward-locked position of the advance wheel mechanism 203.

It is noted that if, at a time just prior to the switch from the fourth point of the film cycle to the fifth point, the user has not yet pre-wound all of the available film out of the film cassette housing 201a, stopping for example at a point when the counter dial indicated 24 available exposures although sufficient film for 36 exposures was in fact available, and the user then switches to the fifth point of the film cycle, the 12 exposures which were yet to be pre-wound out of the film cassette housing at that point will, in accordance with the present invention, remain thereafter within the housing, not to be removed unless for film development purposes after the photographic film cassette 201 is removed from the camera. This is because advance wheel claw 207, from that point forward, will be engaged with the film winding spool 201b of the photographic film cassette 201, and the advance wheel 206, which would otherwise rotate with the advance wheel claw if the strip 201c of photographic film were to be pulled back out of the film cassette housing 201a by further winding of winding key 260, is prevented from so rotating in the pre-wind direction by a cantilevered ratchet arm 750 which constantly engages the advance wheel knurling 206f and allows rotation in the rewind direction only. Such an arrangement prevents any portion of film, once exposed by a user, from being exposed again.

Referring to FIG. 8A and FIG. 8B, the sixth point of the film cycle is shown. The camera 100 is now prepared for the user to begin taking photographs. At first, the user begins to turn the advance wheel 206 in the rewind direction, thus beginning the process of rewinding the strip 201c of photographic film back into the film cassette housing 201a. Because the edge-located gear-engaging perforations 201d of the film are engaged with the film engagement teeth 23 1c of the sprocket 231, the shaft spindle 232d will begin to turn the counter dial (not shown), and the ratchet plate 233 will engage the ratchet prong engagement teeth 234b of the cam plate 234, beginning to turn it as well. As will be readily appreciated by those of skill in the art, mechanisms (not shown) within the camera driven by the cam plate 234 operate to a) lock the advance wheel before every exposure, b) trigger the displacement of the shutter (not shown) to expose the film, and c) release the advance wheel for further winding of the film after exposure. This pattern is repeated until the counter dial indicates (whether with an ‘S’ or some other appropriate indicator) that all the film is exposed and rewound back into the film cassette housing 201a. The user will be prevented from accomplishing any further pre-wind of the film, whether by using the winding key 260 to turn the rotation interface 253 in the pre-wind direction, or by using any other method of turning the pre-wound film take-up spool 242, because of the combination of a) the engagement of the film winding spool 201c of the photographic film cassette 201 by the advance wheel claw 207 (which will persist until the rear door is released from the camera housing), and b) the ratchet action of the cantilevered ratchet arm 750 of the top plate which constantly engages the knurling 206f of the advance wheel 206 and prevents the advance wheel from rotating in any other way than the rewind direction.

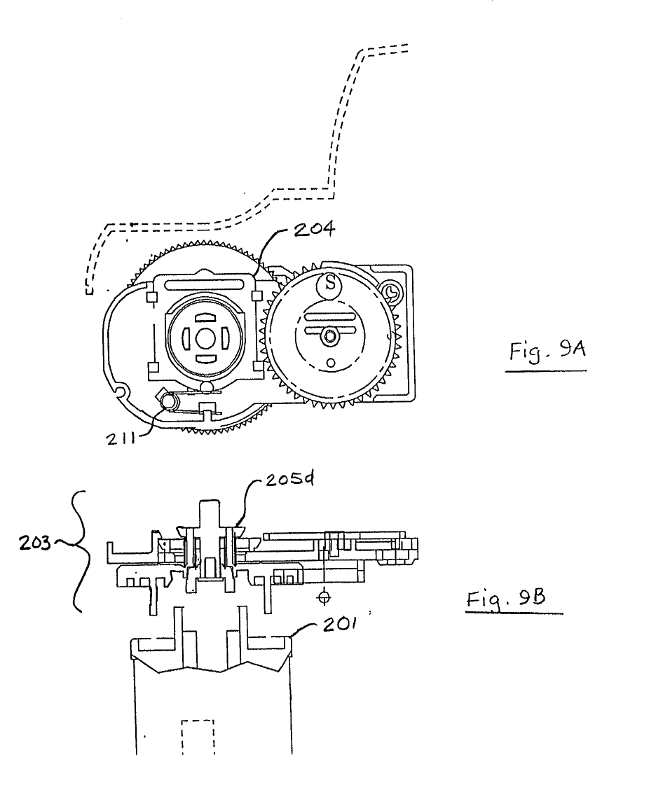

Referring to FIG. 9, the seventh point of the film cycle is shown. The counter dial indicates with an ‘S’ that the film is fully exposed and rewound. At this point, the rear door may be released from the camera housing without risking unwanted exposure of the film. After the rear door is released, the knob stopper 204, because it is no longer urged forward by the superior force created by the presence of the rear door, is once again urged rearward by the lesser force of the top plate resilient member 211. This moves the knob stopper away from its obstructing ‘ceiling’ position relative to the advance wheel knob top surface 205d, and the knob and claw portion of the advance wheel mechanism 203 is urged upward by the large resilient member 208. The photographic film cassette 201 can be removed from the camera at this time and the film cycle described above can be begun again at the first point with a new roll of film.

What is claimed is:

1. A film transport mechanism for a roll film camera, said roll film camera having a structural housing, said structural housing including a receiving chamber for selectably fixing the position of the cassette housing of a photographic film cassette with respect to said structural housing, said photographic film cassette further having a strip of photographic film and a torque-accepting interface, integrated within said cassette housing, and adapted to permit torque generated external to said cassette housing to rewind said strip of photographic film back within said photographic film cassette, said mechanism comprising:
a shaft element with a first rotational axis and having attached to a first end thereof a pall clutch assembly adapted to rotatably engage, in the rewind direction, the torquing interface of a photographic film cassette installed within said recieving chamber of said camera;
a film advancing wheel with a second rotational axis, rotatably attached to said structural housing of said roll film camera, adapted to permit a user of said roll film camera to generate torque for rewinding said strip of photographic film within said cassette housing of said photographic film cassette;
means for transmitting said rewinding torque from said film advancing wheel to said shaft element;
biasing means for axially moving said shaft element away from said torque-accepting interface of said photographic film cassette and thereby preventing torque-transmitting engagement between said pall clutch assembly and said torquing interface of said photographic film cassette;
means for allowing a user of said roll film camera to selectably defeat said biasing means by causing said shaft element to axially move toward said torque-accepting interface of said photographic film cassette and causing torque-transmitting engagement between said pall clutch assembly and said torquing interface of said photographic film cassette;
means for preventing said advancing wheel from rotating in the pre-wind direction when said pall clutch assembly and said torquing interface of said photographic film cassette are in said torque-transmitting engagement;
means for maintaining torque transmitting engagement between said pall clutch assembly and said torquing interface of said photographic film cassette after said defeating of said biasing means; and
means for releasing said maintaining means, thereby allowing said biasing means to move said shaft element away from said torquing interface of said photographic film cassette.

2. The film transport mechanism of claim 1, said first and second rotational axes being substantially in alignment.

3. The film transport mechanism of claim 2, said transmitting means comprising a plurality of locating posts radially arrayed around said second rotational axis and fixed to a first upward-facing surface of said advance wheel, and a plurality of locating sleeves, adapted to mate with said locating posts, passing through a downward-facing surface of said shaft element.

4. The film transport mechanism of claim 3, said film transport mechanism further comprising means for preventing said locating posts from becoming unmated from said locating sleeves.

5. The film transport mechanism of claim 4, said unmating preventing means comprising substantial mechanical interference between a downward-facing surface of said film advance wheel and an upward-facing surface of said pall clutch.

6. The film transport mechanism of claim 2, said biasing means comprising a coil-shaped spring, said coil-shaped spring being substantially aligned with said first and second rotational axes and being interposed between a downward-facing surface of said shaft element and an upward facing surface of said film advance wheel.

7. The film transport mechanism of claim 1, said biasing means comprising a resilient member interposed between a downward facing surface of said shaft element and an upward facing surface of said film advance wheel.

8. The film transport mechanism of claim 1, said allowing means comprising a portion of said shaft element extending beyond said camera housing adapted to allow said user to axially push said shaft element downward.

9. The film transport mechanism of claim 1, said pre-wind rotation prevention means comprising film advance wheel ratcheting means.

10. The film transport mechanism of claim 9, said film advance wheel ratcheting means comprising knurling on a circumferential surface of said film advance wheel and a ratchet arm in cantilevered communication with said camera housing, the distal end of said ratchet arm being in pre-tensioned contact with circumferential surface of said film advance wheel, said distal end of said ratchet arm having a geometry adapted to mate with said knurling, to allow rotation of said film advance wheel in said rewind direction, and to prevent rotation of said film advance wheel in the direction opposite said rewind direction.

11. The film transport mechanism of claim 1, said maintaining means comprising a blocking member, said blocking member being adapted to be placed in a blocking position with regard to said shaft member such that said blocking member prevents upward axial motion of said shaft member by interposing a downward facing surface of said blocking member in the upward path of an upward-facing surface of said shaft member.

12. The film transport mechanism of claim 11, said maintaining means further comprising a door of said camera housing adapted, when shut against said camera housing, to hold said blocking member in said blocking position.

13. The film transport mechanism of claim 12, said maintaining means further comprising a latch adapted to hold said door closed.

14. The film transport mechanism of claim 13, said releasing means further comprising means to release said latch and allow said door to be opened, said releasing means being adapted to be operated repeatedly without substantial deterioration of said closing function of said latch.

15. The film transport mechanism of claim 11, further comprising downward axial motion accommodating means adapted to allow said blocking member to be placed in said blocking position, and to substantially maintain said blocking member in said blocking position while said allowing means are employed by said user to defeat said biasing means and move said shaft member axially downward past said blocking member.

16. The film transport mechanism of claim 15, said downward axial motion accommodating means comprising a first angled surface facing downward on said shaft member, a second angled surface facing upward on said blocking member adapted to slidably engage said first angled surface as said user moves said shaft member axially downward, and tilt-enabling resilient means incorporated within said roll film camera adapted to allow said blocking member to move slightly away from said blocking position sufficient to allow said shaft member to axially move downward past said blocking member, and to allow said blocking member to revert to said blocking position after said shaft member has axially moved downward past said blocking means.

17. The film transport mechanism of claim 16, said tilt-enabling resilient means including means to permit elastic deformation of said blocking member within said roll film camera.

18. The film transport mechanism of claim 17, said elastic deformation means comprising a leaf spring mechanism integrated within said blocking means.

19. The film transport mechanism of claim 16, said tilt-enabling resilient means including a door to said camera housing in communication with said blocking member, said door being adapted to bow outward from said camera housing in response to said slight movement of said blocking member caused by said downward axial movement of said shaft member.

20. The film transport mechanism of claim 1, said releasing means comprising blocking member biasing means adapted, when unopposed, to urge said blocking member away from said blocking position.

21. An arrangement for moving a strip of photographic film in a camera relative to a photographic film cassette from which said strip of photographic film extends, said photographic film cassette also having a film winding spool, said arrangement comprising:
an advance wheel mechanism rotatably secured within said camera and adjacent to said photographic film cassette, said advance wheel mechanism having an advance wheel adapted to be rotated by a user of said camera, and a claw arrangement adapted to rotatably engage said film winding spool in a first direction;
a plurality of vertically-oriented rails attached to a top surface of said advance wheel and a plurality of vertically-oriented sleeves within said claw arrangement adapted to slidably accommodate said plurality of vertically-oriented rails, said plurality of vertically-oriented rails being slidably disposed within said plurality of vertically-oriented sleeves, and said claw arrangement having an uppermost limit to its vertical traverse along said plurality of rails;
a first resilient member compressibly disposed around said plurality of rails tending to urge said claw arrangement upward along said plurality of rails to said uppermost limit of said vertical traverse, said claw arrangement being prevented, while at said uppermost limit of said vertical traverse, from rotatably engaging said film winding spool;
said advance wheel mechanism being adapted to permit application of a force opposing the force of said first resilient member sufficient to urge said claw arrangement downward along said plurality of rails to a point where said rotatable engagement between said claw arrangement and said film winding spool of said photographic film cassette is facilitated, thereby allowing said user to rotate said film winding spool in said first direction.

22. A method for moving a strip of photographic film relative to the photographic film cassette from which said strip of photographic film extends, said strip of photographic film having a first end and a second end, said photographic film cassette having a film winding spool, said first end of said strip of photographic film being attached to said film winding spool and said second end of said strip of photographic film extending from said camera, said photographic film cassette being in the photographic film cassette storage area of a camera, said camera further having a pre-wound film storage area, said camera having rewinding means for selectably rotatably engaging said film winding spool in a first direction into said photographic film cassette, said camera further having disengagement means for disengaging said rewinding means from said film winding spool, said rewinding means being initially disengaged from said film winding spool, said method comprising:
pre-winding said strip of photographic film out of said photographic film cassette and into said pre-wound film storage area;
rotatably engaging said rewinding means with said film winding spool;
rewinding said strip of photographic film back within said photographic film cassette;
disengaging said rewinding means from said film winding spool; and
removing said photographic film cassette from said camera.
